(19) United States
(12) Patent Application Publication
(10) Pub. No.: US 2008/0083997 A1
(43) Pub. Date: Apr. 10, 2008

(54) System for generating tiny bubbles in water

(76) Inventors: Kuo-Chuan Wu, Chiayi County (TW); Chuan-Lun Wu, Chiayi County (TW)

Correspondence Address: CHARLES E. BAXLEY, ESQ., 90 JOHN STREET, THIRD FLOOR, NEW YORK, NY, 10038, US

(21) Appl. No.: 11/544,091

(22) Filed: Oct. 6, 2006

(51) Int. Cl. B01F 3/04

(52) U.S. Cl. 261/93

(57) ABSTRACT

A bubble generating system includes a centrifugal pump which has a front frame and a rear frame, wherein a plurality of inlets are defined in the front frame and communicates with a center passage of the centrifugal pump. A water tank is connected with the centrifugal pimp and supplies water into the centrifugal pump. An air supplier has a plurality of supply pipes connected with the inlets so as to introduce high pressurized air into the centrifugal pump. A tub has a first pipe connected to nozzles of the tub and a second pipe recycles the water in the tub back to the centrifugal pump.

### FIELD OF THE INVENTION

The present invention relates to a system for generating tiny bubbles in water which is used for hot tub or the like.

### BACKGROUND OF THE INVENTION

A conventional system for generating tiny bubbles in water generally includes a plurality of mushroom-shaped protrusions formed on an inside of the pump so that when water hits the protrusion, bubbles are generated. Another system for generating tiny bubbles in water uses a high pressure pipe which is connected with a water pipe so as to introduce high pressurized air into the water to generate bubbles.

In practice, these two conventional systems are used before the water with bubbles is supplied into the hot tub, and the bubbles in the water cannot stand long when the water is supplied in the hot tub.

The present invention intends to provide a system for generating tiny bubbles in water and the bubbles can last long enough so that when the water is injected into the hot tub, the bubbles are well maintained.

### SUMMARY OF THE INVENTION

The present invention relates to a bubble generating system that comprises a centrifugal pump having a front frame and a rear frame. A plurality of inlets are defined in the front frame and communicate with a center passage of the centrifugal pump. A water tank is connected with the centrifugal pimp so as to supply water into the centrifugal pump. An air supplier has a plurality of supply pipes connected to the inlets so as to introduce high pressurized air into the front frame. A tub has a first pipe and a second pipe connected thereto. The centrifugal pump is connected between the first and second pipes, and the water with bubbles generated by the pressurized air is ejected into the tub via the second pipe. The water in the tub is then recycled back to the centrifugal pump by the first pipe.

The primary object of the present invention is to provide a system for generating bubbles in water and the bubbles in the water are fine and the number of the bubbles is significant.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a diagram of the system of the present invention;

FIG. 2 is a perspective view to show a part of the system of the present invention;

FIG. 3 is a cross sectional view to show that the supply pipes are connected to the front frame of the centrifugal pump;

FIG. 4 shows another embodiment of the system of the present invention, wherein a cap is connected to the front frame;

FIG. 5 is an end cross sectional view along line A-A in FIG. 4, and

FIG. 6 is a side cross sectional view along line B-B in FIG. 4.

### DETAILED DESCRIPTION OF THE PREFERRED EMBODIMENT

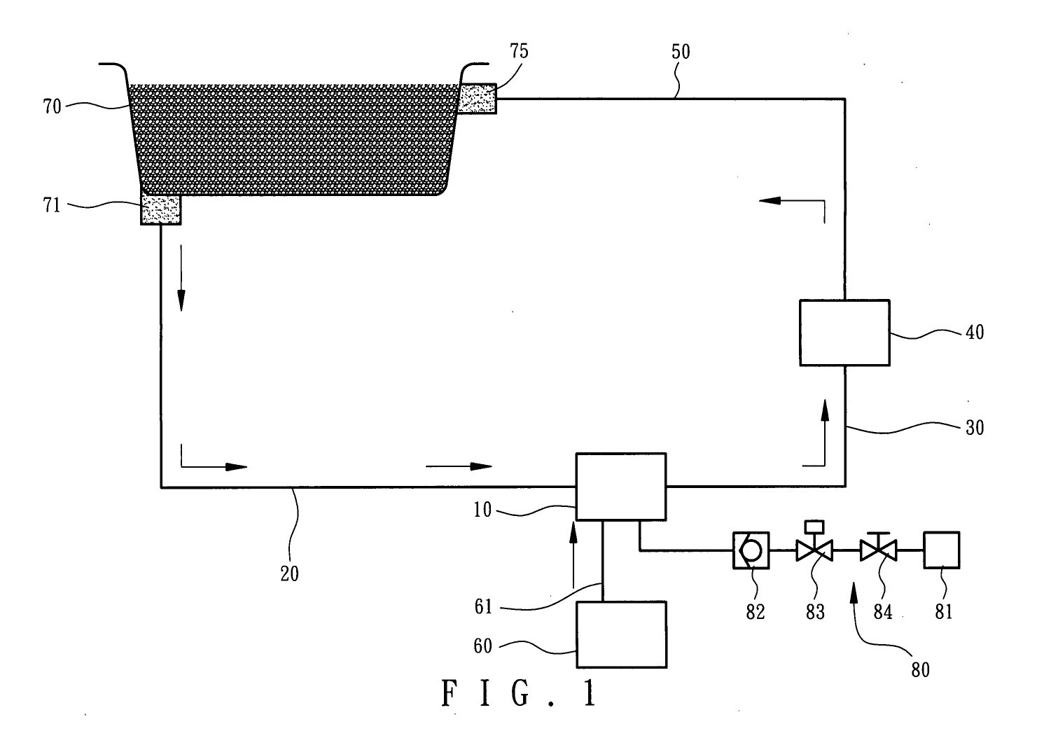

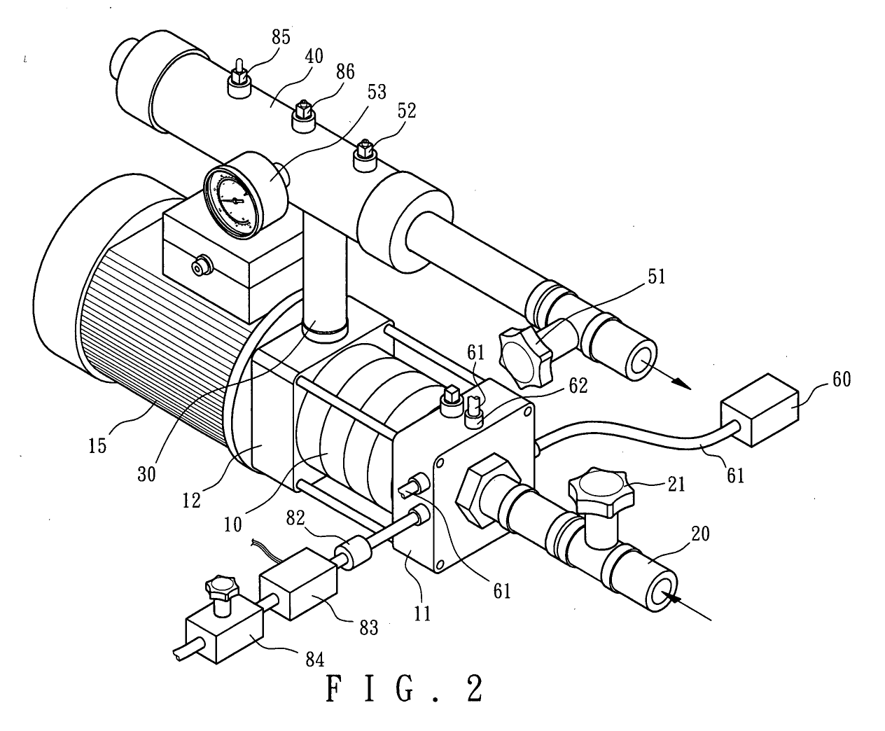

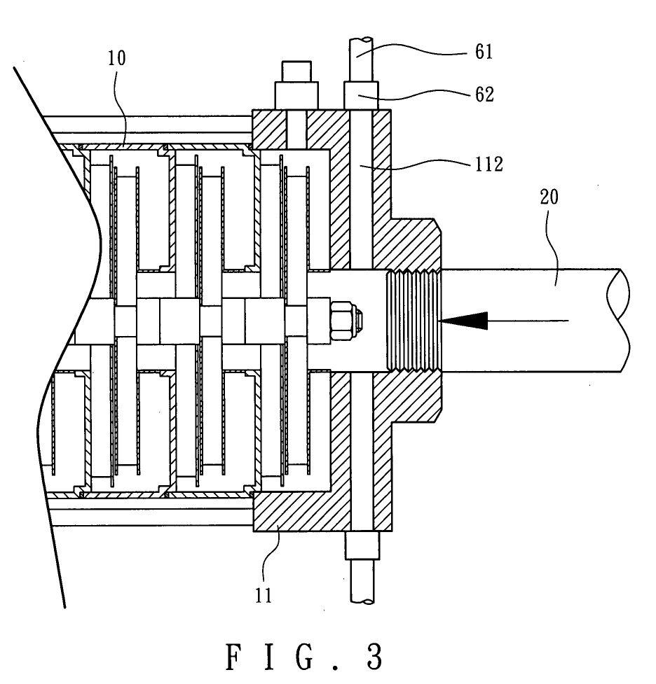

Referring to FIGS. 1 to 3, the system for generating bubbles in water of the present invention comprises a centrifugal pump 10 having a front frame 11 and a rear frame 12. A driving member 15 is connected to the rear frame 12 so as to drive a shaft in a central passage (both not shown). A plurality of inlets 112 are defined in the front frame 11 and communicates with the center passage of the centrifugal pump 10. A water tank 81 is connected with the centrifugal pimp 10 so as to supply water into the centrifugal pump 10. A hot tub 70 for example, is connected to the centrifugal pump 10 and has a first pipe 50 and a second pipe 20 connected thereto. The centrifugal pump 10 is connected between the first and second pipes 50, 20 so that the water with bubbles is ejected into the hot tub 70. A plurality of nozzles 75 are connected to the hot tub 70 and connected with the second pipe 50 so that the water can be ejected into the hot tub 70. The second pipe 20 is connected with a drain valve 71 connected to the tub 70 and extends into the front frame 11 so that the water in the hot tub 70 is recycled back to the centrifugal pump 10.

An air supplier 60 has a plurality of supply pipes 61 extending therefrom and the supply pipes 61 connected to the inlets 112 via connectors 62 engaged with the inlets 112.

An output pipe 30 is connected to the rear frame 12 and a high pressure tank 40 is connected to the output pipe 30. The first pipe 50 has one end connected with the nozzles 75 of the tub 70 and the other end of the first pipe is connected with the high pressure tank 40.

Each of the first pipe 50 and the second pipe 20 has a control valve 51/21 connected thereto so as to close or open the first and second pipe 50, 20 when needed. The high pressure tank 40 includes a pressure releasing valve 52 and the first pipe 50 has a gauge 53 for displaying temperature and pressure of water.

When the centrifugal pump 10 is activated, water is supplied into the centrifugal pump 10 via the second pipe 20, and pressurized air is introduced into the centrifugal pump 10 via the supply pipes 61 and the inlets 112. The centrifugal force mix the water and the high pressurized air to generate fine bubbles. The water with fine bubbles is then sent into the high pressure tank 40 via the output pipe 30 to maintain the bubbles in the water. The water then is sent to the nozzles 75 via the first pipe 50 and ejected into the hot tub 70. The water in the hot tub 70 is recycled via the drain valve 71 and the second pipe 20 back to the centrifugal pump 10.

A water pressure regulation unit 80 is connected to the front frame 11 of the centrifugal pump 10 and includes the water tank 81, a one-direction valve 82 to prevent the water from flowing back to the water tank 81, an electro-magnetic valve 83 for controlling the water pressure regulation unit 80, and a volume valve 84 connected on a pipe connected between the water tank 81 and the front frame 11. A low pressure controller 85 and a high pressure controller 86 are connected to the high pressure tank 40, wherein the lower pressure controller 85 is able to activate the water tank 81 to supply water into the centrifugal pump 10 when the pressure in the high pressure tank 40 is low, and the high pressure controller 86 stops the centrifugal pump 10 when the pressure in the high pressure tank 40 is high.

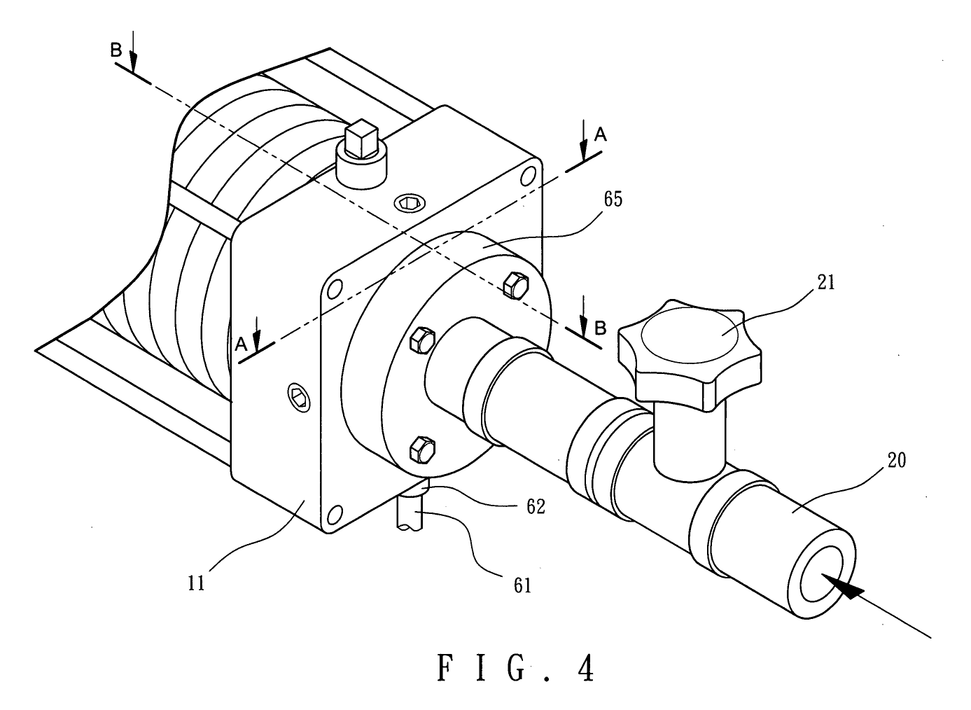

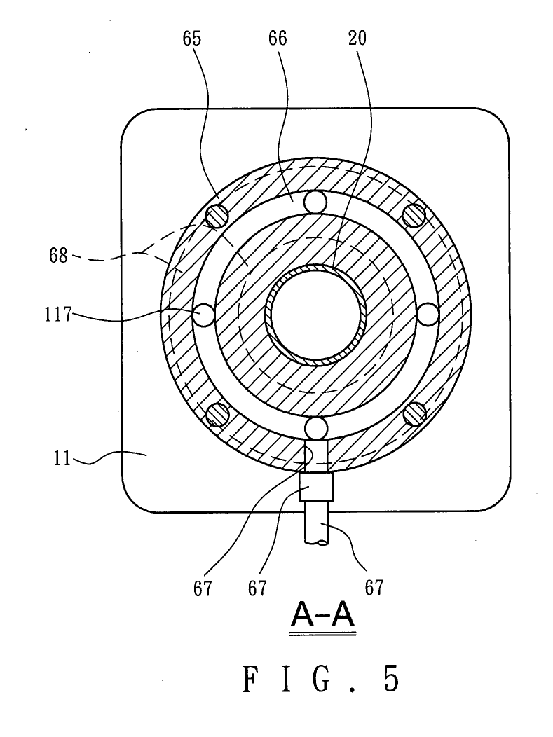

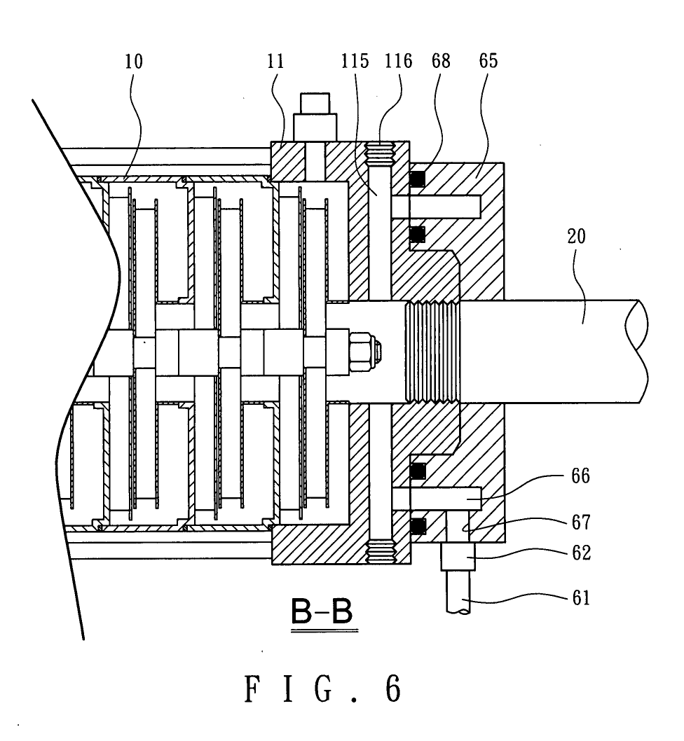

Referring to FIGS. 4, 5 and 6, another embodiment of the system is disclosed and the main difference from the first embodiment in FIGS. 1 to 3 is that a cap 65 is connected to the front frame 11. Two seal rings 80 are connected between the cap 65 and the front frame 11. Each radial inlet 115 is re sealed by seal bolts 116. A plurality of paths 117 are defined in the front frame 11 and communicating with the radial inlets 115. The second pipe 20 extends through the cap 65. An annular groove 66 is defined in the cap 65 and communicates with the paths 117. A plurality of apertures 67 are defined through the cap 65 and communicate with the annular groove 66. Each aperture 67 has a connector 62 engaged therewith and the supply pipes 61 connected with the connectors 62.

While we have shown and described the embodiment in accordance with the present invention, it should be clear to those skilled in the art that further embodiments may be made without departing from the scope of the present invention.

What is claimed is:

1. A bubble generating system comprising:
a centrifugal pump having a front frame and a rear frame, a plurality of inlets defined in the front frame and communicating with a center passage of the centrifugal pump, a water tank connected with the centrifugal pimp;
an air supplier having a plurality of supply pipes extending therefrom and the supply pipes connected to the inlets via connectors engaged with the inlets, and
a tub having a first pipe and a second pipe connected thereto, the centrifugal pump connected between the first and second pipes.

2. The system as claimed in claim 1, wherein a driving member is connected to the rear frame of the centrifugal pump, the second pipe is connected with a drain valve connected to the tub and extends into the front frame, an output pipe is connected to the rear frame and a high pressure tank is connected to the output pipe, the first pipe has one end connected with a nozzle of the tub and the other end of the first pipe is connected with the high pressure tank.

3. The system as claimed in claim 1, wherein each of the first pipe and the second pipe has a control valve connected thereto so as to close the first and second pipe, the high pressure tank includes a pressure releasing valve and the first pipe has a gauge for displaying temperature and pressure of water.

4. The system as claimed in claim 1, wherein a water pressure regulation unit is connected to the front frame of the centrifugal pump and includes the water tank, a one-direction valve, an electro-magnetic valve and a volume valve connected on a pipe connected between the water tank and the front frame.

5. The system as claimed in claim 4, wherein a low pressure controller and a high pressure controller are connected to the high pressure tank, the lower pressure controller activate the water tank to supply water into the centrifugal pump when the pressure in the high pressure tank is low, the high pressure controller stops the centrifugal pump when the pressure in the high pressure tank is high.

6. A bubble generating system comprising:
a centrifugal pump having a front frame and a rear frame, the front frame of the centrifugal pump including radial inlets which communicate with a center passage of the centrifugal pump, each radial inlet being sealed by seal bolts, a plurality of paths defined in the front frame and communicating with the radial inlets, a water tank connected with the centrifugal pimp;
an air supplier having a plurality of supply pipes extending therefrom;
a tub having a first pipe and a second pipe connected thereto, the centrifugal pump connected between the first and second pipes, and
a cap connected to the front frame and the second pipe extending through the cap, an annular groove defined in the cap and communicates with the paths, a plurality of apertures defined through the cap and communicating with the annular groove, each aperture having a connector engaged therewith and the supply pipes connected with the connectors.

7. The system as claimed in claim 6, wherein a driving member is connected to the rear frame of the centrifugal pump, the second pipe is connected with a drain valve connected to the tub and extends into the front frame, an output pipe is connected to the rear frame and a high pressure tank is connected to the output pipe, the first pipe has one end connected with a nozzle of the tub and the other end of the first pipe is connected with the high pressure tank.

8. The system as claimed in claim 6, wherein each of the first pipe and the second pipe has a control valve connected thereto so as to close the first and second pipe, the high pressure tank includes a pressure releasing valve and the first pipe has a gauge for displaying temperature and pressure of water.

9. The system as claimed in claim 6, wherein a water pressure regulation unit is connected to the front frame of the centrifugal pump and including the water tank, a one-direction valve, a electro-magnetic valve and a volume valve are connected on a pipe connected between the water tank and the front frame.

10. The system as claimed in claim 9, wherein a low pressure controller and a high pressure controller are connected to the high pressure tank, the lower pressure controller activate the water tank to supply water into the centrifugal pump when the pressure in the high pressure tank is low, the high pressure controller stops the centrifugal pump when the pressure in the high pressure tank is high.

11. The system as claimed in claim 6, wherein two seal rings are connected between the cap and the front frame.
